(19) United States
(12) Patent Application Publication
(10) Pub. No.: US 2017/0235729 A1
(43) Pub. Date: Aug. 17, 2017

(54) Subtitling Method and System

(71) Applicant: British Broadcasting Corporation, London (GB)

(72) Inventors: Chris HUGHES, London (GB); Mike ARMSTRONG, London (GB)

(21) Appl. No.: 15/518,912

(22) PCT Filed: Oct. 14, 2015
(86) PCT No.: PCT/GB2015/053026

§ 371 Date: Apr. 13, 2017

(30) Foreign Application Priority Data
Oct. 15, 2014 (GB) 1418261.2

(51) Int. Cl. G06F 17/30

(52) U.S. Cl. CPC G06F 17/30038; G06F 17/30743; G06F 17/30784

(57) ABSTRACT

A method of retrieving supplementary data related to audio-video content with reference to a reference version of that content involves deriving an audio signature from audio-video content. The audio signature is searched against reference audio signatures of reference versions of the audio-video content. If a match is found, supplementary data related to the reference audio-video content is retrieved. The search is a directed search using data extracted from the transmission route by which the audio-video content is to be delivered to a consumer. The search process is thereby more efficient as the search may be started at an appropriate location or conducted in an appropriate direction, rather than searching blindly.

### BACKGROUND OF THE INVENTION

This invention relates to obtaining data related to audio-video content in situations in which such data may already be available, but not linked to the audio-video content.

Audio-video content such as television programmes and the like may be distributed to consumers via a variety of media. Traditional linear television programmes are broadcast over a broadcast network, whether terrestrial, cable or satellite and may be consumed by users by a variety of receiver devices. Such audio-video content includes the audio and video components and may also include additional content such as subtitles, audio description and other additional data. Such audio-video content may also be distributed via additional routes, in particular via on demand services such as on the internet. In the process of repurposing audio-video content for other distribution channels, though, additional content such as subtitles, audio description or other data or metadata is not routinely copied with the result that such additional content is not available on the version distributed by the additional distribution route. Similar issues can occur when audio-video content is re-versioned for broadcast.

We have appreciated the need to allow for data related to audio-video content, in particular supplementary data such as subtitles, should be easily retrieved for use with a complete or partial copy of that audio-video content.

### SUMMARY OF THE INVENTION

The present invention provides a system and method for retrieving

supplementary data related to audio-video content in relation to a complete or partial copy of that audio-video content using a signature of the audio component of the audio-video content and matching such a signature to a reference signature to extract supplementary data for the audio-video content.

The embodiment of the invention preferably uses a feature extraction technique that produces a signature of the audio component. The signature may be variable in length so as to allow matching of an entire television programme, portion of a programme, or edited version, thereby allowing matching of an edited version of a programme against an original programme.

The signature (which may also be referred to as a fingerprint) may be any process or function which reduces the amount of information and complexity in the representation of the data which retains a low likelihood of correlation with a signature from an unrelated set of data whilst ensuring repeatable correlation when comparing similar signals. In the embodiment, the signature preferably retains a temporal resolution of around a second so that the location of the matching audio can be located to a similar resolution.

The search strategy may be to match using audio fingerprints alone, but preferably additional data is used to direct the search, in particular a date time field that specifies a date related to the audio video content such as the date it was first broadcast, which can then be used to direct the order of the search against the database containing the audio features and the supplementary data. Such an approach is particularly applicable to topical audio-video content presented on websites shortly before or after a date of first broadcast over a traditional channel. Additional data is also preferably used to direct the search, such as a category, channel or keywords.

### BRIEF DESCRIPTION OF THE DRAWINGS

The invention will be described in more detail by way of example with reference to the accompanying drawings, in which:

FIG. 1 shows the process for creating a database of audio signatures for subsequent searching;

FIG. 2 shows the process for searching the database to find matching audio signatures;

FIG. 3 shows a sliding search illustrating the matching of fingerprints; and

FIG. 4 shows the partial matching of signatures to allow identification of clips within a programme.

### DETAILED DESCRIPTION OF A PREFERRED EMBODIMENT OF THE INVENTION

The main embodiment that will be described is a method and system for obtaining subtitles that have already been created for one copy of audio-video content, that may be referred to as a reference copy, and providing them for another copy of that audio-video content. In the example given, the reference copy of the audio-video content may be an originally broadcast version sent over a communication channel such as terrestrial, satellite or cable. The second copy of the same audio-video content may be the whole or a portion of that content made available via the internet such as a website, dedicated online player or similar. The approach is operated by an embodiment to search for the same video clip in an archive or library of broadcast content for which subtitles have already been authored. These subtitles are then reformatted to a form suitable for that clip including error corrections and retiming.

This approach could also be used to retrieve any other data which is stored alongside the audio and video content, such as timing triggers for an interactive app or a list of shot changes or script information describing the scene or the characters/actors in the scene. Such data may generally be referred to as supplementary data.

The search is done using available data about the clip, and its audio and/or video content. The data in a web page may include the programme title and date of broadcast, or other text that suggests its approximate time and date of broadcast that can narrow the search down to a single day or programme. It may even contain the start time of the clip. The method enables the location of corresponding supplementary data to be found, even without supporting data, provided it exists in the archive/library.

The preferred method is to perform a comparison between the video clip audio signal and the contents of the archive/library. The audio signal is preferred as the search method because it relates directly to the main example of supplementary data, namely words in the subtitles, whereas the video may have been reused with a different soundtrack, which would contain different words to the clip being searched. In the case of data that relates to the video signal, such as audio description, the video signal would be preferred.

Refinements to this method can be applied to speed up the process and make the implementation practicable. These include methods such as using fingerprints generated from the audio and/or video content of the clip and a database of fingerprints for the archive/library. It may also be possible to use speech to text technology to generate semantic data from the clips to directly interrogate an archive of subtitles files to find a match.

The embodiment focuses matching the audio extracted from a web clip to audio stored in an archive. The example implementation does this by generating a fingerprint for the audio of all broadcast content and storing it in a database, alongside the matching subtitles, making it possible to rapidly search the database for the matching clips and provide the matching subtitles. However, this search could also use video fingerprints and any other metadata to identify when and where the clip was (or will be) broadcast. The preferred embodiment also includes various search heuristics to identify the fingerprint match and novel approaches to tidying up and retiming the subtitles to improve their quality, particularly if the subtitles were generated live.

### System Overview

An overview of the main components of a system embodying the invention will first be described, followed by an explanation of the process for creating a fingerprint database and then a description of the process for searching the database.

A server is used to maintain and update a database of fingerprints. The system preferably maintains such a database for all content broadcast on traditional linear broadcast for at least the main channels. As new content is broadcast on the conventional channels the matching audio is cached and a fingerprint is generated providing a small representation of the audio file (˜2% of the size of the equivalent MP3 file). This fingerprint is then written to the database along with the matching subtitles that were broadcast live. Any other metadata (such as channel, programme name etc.) are also stored in the database.

The Server provides a search mechanism, which can be invoked by providing a URL from a website with web clips identified by a unique URL address. Once the search starts it visits the URL, downloads the video clip from the page, extracts the audio and generates a fingerprint representation for the clip. It also extracts meta-data from the web page (such as the creation time and date of the page, if it is news etc.) This meta-data is used to create a heuristic search through the database, by weighting each of the database entries based on time and date, channel and keywords found. The search algorithm then does a brute force search through the database, doing a cross correlation between the clip fingerprint and each entry in the database. Two thresholds are specified in the parameters, if the correlation error is below the first threshold it is assumed to be a highly likely match and returns an immediate result. If this is not found but the lowest error is below the second threshold once the search has completed, it is believed to be a very likely match and that result returned. A match will not found if the clip has been edited together from a number of separate excerpts as the fingerprint will not be continuous within the reference database.

In order to allow for edited clips to be found, the algorithm firstly searches for the beginning of the web clip. Once it finds a match, it then grows the fingerprint length until it no longer matches signifying that an edit has occurred. The search then starts again from the point of the known edit to identify the subtitles for several sub clips. The retrieved subtitles may then be cleaned up such as by removing the repeated words present in live subtitle streams. Natural language processing may be used to identify the most likely start and end of the required subtitles and to correct incorrect words where the subtitler provided a correction. Also colours are corrected and subtitle files are generated. Finally a web-based editor provides full editorial control, to correct any errors that occurred in the live subtitles. It also includes other tools, such as a one-click manual retiming tool, the ability to import text from other sources, such as transcripts and original scripts (in case no matches were found). It also includes the functionality to pass the edited subtitles and audio through our phonetic retiming service (running on the same server) to provide an autonomous retiming tool. The web editor also provides warnings to indicate whether the current subtitles meet guidelines, such as showing the reading rate in words per minute for each subtitle.

### Database Creation

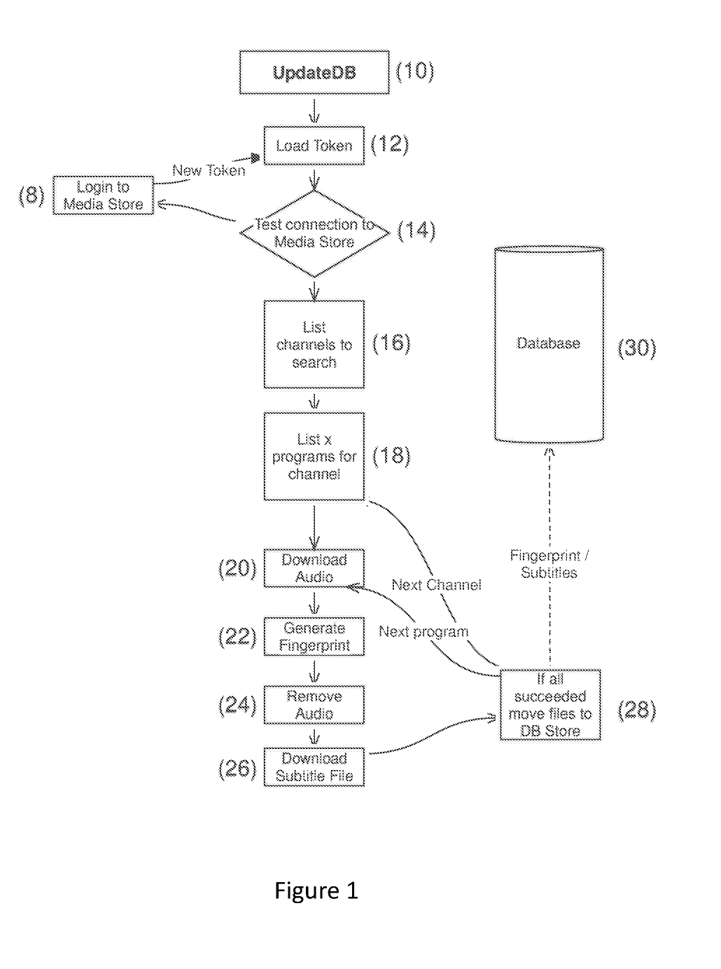

FIG. 1 shows the process by which a database of fingerprints may be created. The embodiment may be implemented as dedicated hardware or as routines in software and so FIG. 1 may also be considered a functional diagram of separate modules. A variety of fingerprinting techniques may be used by which the audio features are extracted. Common to all such techniques is a reduction in the complexity of the original audio signal to the audio feature signal. In addition, the feature extraction process preferably avoids problems such as differences in amplitude of signals by deriving inherent characteristics of the signals. As previously noted, the embodiment of the invention preferably uses a feature extraction technique that produces a signature of the audio component. The signature may be variable in length so as to allow matching of an entire television programme, portion of a programme, or edited version, thereby allowing matching of an edited version of a programme against an original programme.

The signature (which may also be referred to as a fingerprint) may be any process or function which reduces the amount of information and complexity in the representation of the data which retains a low likelihood of correlation with a signature from an unrelated set of data whilst ensuring repeatable correlation when comparing similar signals. In the embodiment, the signature preferably retains a temporal resolution of around a second so that the location of the matching audio can be located to a similar resolution. A variety of different fingerprint techniques will now be discussed.

The embodiment of the invention is arranged to create a fingerprint of audio-video content whenever an update to a database of audio-video content is detected. In this way, the system may be used to automatically create a fingerprint database from continually delivered audio-video content. In particular, the system can monitor content broadcast on a range of channels and automatically record the associated fingerprints and supplementary data such as subtitles to database. At step 10 of FIG. 1 an update to a database of audio-video content is detected and at step 12 a token from a recording service is loaded. A connection to the media store is established at step 14. The media store could be built from recordings of off-air broadcasts and/or a library/archive of the broadcast files. A login to the media store is provided at step 8. At step 16, a list of channels for which fingerprints are to be created is searched and at step 18 the programmes for each channel listed. Once the appropriate channels and programmes have been identified, the process proceeds to download a file (such as WAV or MP3) representing the audio component of each programme and generates a fingerprint at step 22.

The downloaded audio file may then be removed at step 24 and a file containing the subtitle data (in a format such as SRT or TTML) downloaded at step 26. At step 28, if all programmes have been completed, the fingerprint and subtitle data is stored in a database at step 30 along with any other data available such as a programme name, date of broadcast and so on. If at step 28 it is determined that there are further programmes to be fingerprinted, the process reverts to step 20 and the next audio file downloaded.

Using the above approach, the database 30 may be created which contains a fingerprint for each portion of audio-video content (programme), the accompanying subtitles including timestamps for the presentation of the subtitles, a channel on which the programme is broadcast, a programme name, programme ID and other data that may be useful in the directed search that will be described later.

A fingerprinting technique (such as ‘FPCALC’) is used in order to create a repeatable set of features that represent the audio in a compressed format. Using a fingerprinting technique reduces the size of the representation, which reduces the time and processing required to complete the search and the storage for the data. For the purpose of locating the subtitle content a granularity of 1 to 2 seconds is appropriate. The fingerprinting technique used may be any of a variety of commercially available algorithms for reducing an audio track to features.

The feature extraction preferably provides a time varying output that varies with the time period of the audio-video content thereby allowing alignment between the reference database and a sample audio-video content so as to find matching parts of the content and also the matching timing for subtitles.

### Data Retrieval

A Database interrogation service is implemented and used to interrogate the database in order to identify where and when a video clip was broadcast by rapidly matching its audio track to the audio stored in the database, using the stored fingerprints. The Service is invoked by providing a URL (for example: http://www.bbc.co.uk/news/uk-england-28685666)—All such web clips can be identified by their unique URL address.

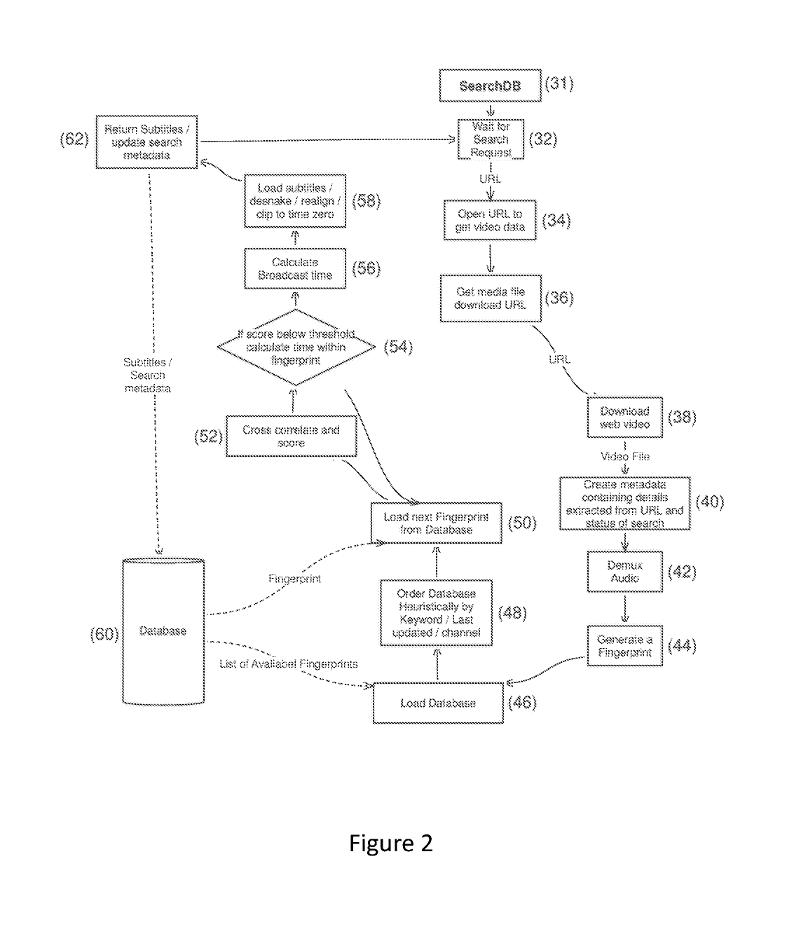

The service then retrieves the video that is hosted on the URL along with its relevant metadata, performs a search against the database and if it is found the matching subtitles is returned as a subtitle file (such as an STL or TTML file) to match the video clip. Caching is also used to improve performance at each stage of the process. FIG. 2 provides an overview of the structure of the Database interrogation architecture.

The search method shown in FIG. 2 uses the fact that the request for subtitles derives from web content on a website identified by a URL and this allows data associated with the URL to be extracted and used as part of a search strategy. At step 31 the search is initialised and step 32 awaits for a first search request. On receiving a URL related to a piece of audio-video content, the programme ID of that content is retrieved and the relevant media server opened to retrieve the highest quality audio-video content available related to the URL and programme ID at step 36. At step 38 the video is downloaded as an audio/video file and at step 40 a metadata containing details extracted from the URL is stored in an exchangeable data format such as JSON or XML. At step 42 the audio component is extracted and the fingerprint generated at step 44 from the audio and is loaded to a database at step 46. This is extracted from the main database containing previously generated fingerprints and the associated subtitles as well as ancillary information such time of broadcast, programme ID, channel and so on.

The database is then ordered by an appropriate heuristic depending upon the information available from the URL for searching. For example, if the URL provides keywords related to the audio-video content, the database may be ordered by keyword. If the URL contains a date that the audio-video content was first broadcast, the database may be ordered by date and/or the channel on which the content was broadcast. A combination of such heuristics may be used to increase the likelihood that the fingerprint would be found quickly. At step 50, each fingerprint is loaded in turn and cross-correlated at step 52 with the fingerprint generated from the content at step 44. If this generates a score below a threshold, the relative offset between the database fingerprint and the fingerprint of the content being analysed may be generated. If the score is above a certain threshold, the next fingerprint is selected from the database and cross-correlation performed again so that the fingerprints are retrieved in turn in the order defined by the heuristic until a match is found. When the match is found and the time within the fingerprint calculated, this is compared to a broadcast time at step 56 and the subtitles retrieved and realigned using the offset time at step 58 and returned to the metadata file at step 62 for returning to the user that requested the subtitles.

The directed search progress will now be described in more detail with reference to some examples.

The video clip is first demuxed (using a tool such as ‘ffmpeg’) to extract its audio track. A fingerprint matching the audio file is then created and stored. A pass is made through the database cross correlating the clip fingerprint to each entry in the database. A confidence value is calculated for every comparison and compared to two threshold values. If the confidence value is less than the first value we are certain to have received a match and the search is stopped. If the confidence value is higher than the first threshold but less than the second value we continue searching to the end in case we find a better match. If we find a match we can extract the matching subtitles from the database and return them to the user.

A database search can be run in one of several modes as determined by the user when starting the service. Examples of operation include:
1. A single exhaustive search is performed based on a supplied URL.
2. A single exhaustive search is performed based on supplied programme identifier, this however means that there is no meta-data available to perform a heuristic based search.
3. A batch search is done on a list of URLs such as that found in an RSS feed.
4. A batch search is performed by creating a list of URLs by following links on a webpage, to a specified depth.
5. A single search is performed with parameters that are all specified within a file.
6. A rapid search by limiting the search depth into the database. This makes it possible to use a search in near real-time whilst browsing video clips, however it does mean that difficult to find video clips may be missed. Any videos not found may be tagged for later exhaustive search.
7. A debugging mode that allow search operations to be repeated.

The search algorithm then does a brute force search through the database, doing a cross correlation between the clip fingerprint and each entry in the database. Our cross Correlation algorithm performs a sliding dot product comparison between the sub fingerprint f(t) within each database entry fingerprint as g(t).

f*g=f*(−t)*g.

To enable the database to be searched in near real-time, a heuristics model is used to search the most likely areas of the database first. The meta-data stored when the file is downloaded is used to create a search through the database, by weighting each of the database entries based on the time the clip was uploaded, most likely channels and keywords on the page.

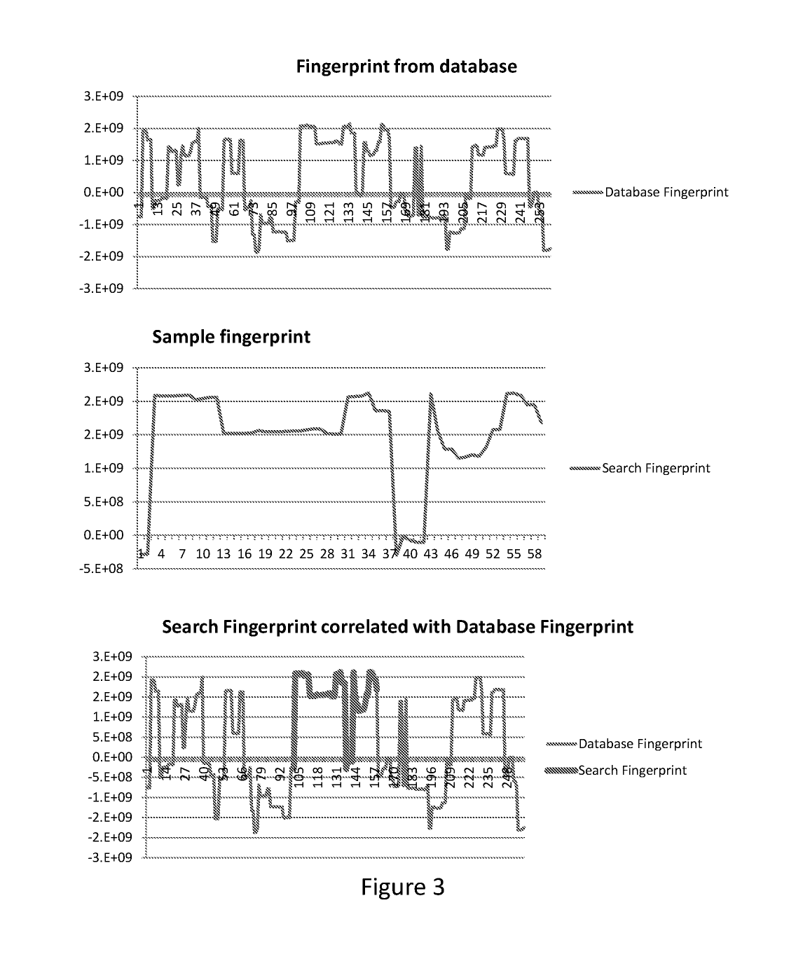

FIG. 3 shows the sliding dot product between a fingerprint from the database and the fingerprint of content being analysed.

As the subtitles stored in the database come from the live broadcast it may be necessary to reconstruct them from the live format into a pseudo-prepared block format. A request is made to the database for all of the subtitles stored between the start and end times of the programme. An offset is provided to ensure we retrieve subtitles from earlier and later than the clip to therefore getting too many subtitled returned at both the beginning and end and we can intelligently trim the subtitles later to ensure we have not missed the start and end point.

The subtitles are initially converted to a single text string, where timing is maintained on a per word basis. Each word is extracted from the live subtitle file and stored in a subtitle object alongside its broadcast timing. Due to the nature of live subtitles, once each line is completed, it is resent as a block. The system simply ignores anything that is not a single word.

Once a text string made up from the live subtitles is retrieved, the system will try and find the most likely start and end point for the text, this generally relies upon looking to start with the beginning of a sentence and ending on a punctuation mark. Starting at the point that the Database interrogation identified as the start time we search forwards and backwards until we find the beginning of a sentence, denoted by both a capital letter and the previous sentence ending with a punctuation mark. Similarly at the end of the subtitle file we look for the closest point at which a sentence ends and then we drop the words that fall outside of this. A parameter in the reconstruction process allows the user to specify that they want to look further forwards or backwards that forces the service to include more or less sentences.

The text string also maintains the original colours that were broadcast live. As it is likely the video has been clipped from the middle of an article the subtitles are likely to start on the wrong colour. We therefore re index the colour back into the standard order of white, yellow, green then blue by creating a lookup table.

The subtitles are reconstructed into blocks, by adhering to a maximum character per line rule. By default this is set at 38 characters as recommended in some industry guidelines, although can be overwritten by the user. Each word is appended to a subtitle block until the next word is too long and forces the letter count over the limit. At which point a break is inserted and we start to fill the next line. Additional rules also avoid leaving orphaned words, by forcing a newline if we receive a punctuation mark over half way through the subtitle line and breaks are always forced when there is a change of speaker. Each line is then assembled into a two linen pair to complete the block.

Finally the subtitles are retimed. As the subtitles have been clipped from a subtitle file representing the entire programme each of the timings relate to the position within the programme. We subtract the found start time from each subtitle in order to realign it with the clip. We also make an assumption that short clips are always cut relatively tightly to the dialog. Therefore we have found reasonable results with scaling our subtitles to fit the video clip. This is done by pulling the first subtitle to the beginning of the clip and pushing the last subtitle so that it ends at the end of the clip. Each subtitle in between is then scaled to fit, maintaining the time ratio from broadcast.

The resulting subtitles and additional metadata are then written to the database cache in a format (such as JSON or XML). This enables the export of the subtitles to be provided in any standard format (such as TTML or STL).

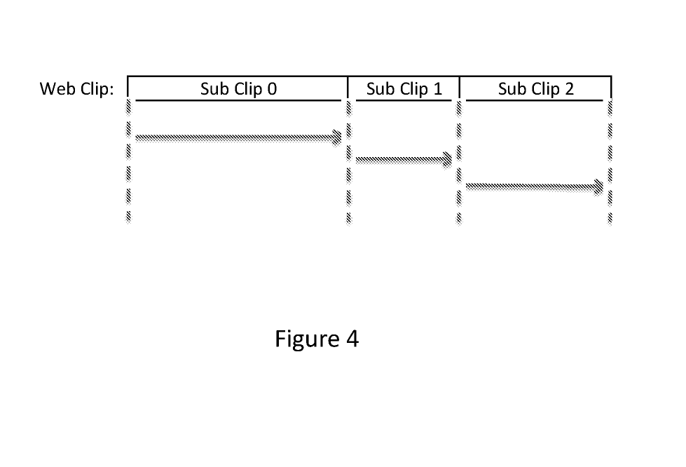

The approach we have described may operate for complete audio-video programmes or portions of audio-video programmes. To do this, instead of comparing the entire signature of a programme against the entire signature of a corresponding programme in the database, portions of signatures may be compared as described below. FIG. 4 shows the approach used.

Instead of searching for the entire fingerprint; the system only searches to find the first 5 seconds. If a match is found the fingerprint is grown in second increments and compared to the database until the fingerprint no longer matches. This is then interpreted as the boundary to the point that the video was edited as shown in FIG. 4. Subtitles are returned for the first section and the process is repeated starting from the boundary point, until each section of the clip had been identified. The user when starting the Database interrogation service can specify a number of parameters. These may include:
1. The URL to search
2. A filename to log the output of each search
3. A list of channels to limit the search
4. A flag to output more detailed debug information during the search
5. A flag which dictates whether to output graphs for checking during the search
6. A flag to specify if the video should be played after the search is complete
7. A flag as to whether to use heuristic search
8. A flag that if set ignores the cache and always overwrites the files
9. The desired bitrate for the downloaded video
10. The maximum length of the search fingerprint
11. An offset value to ignore the beginning of clips which may have a fade
12. The immediate threshold at which point we are confident we have a

correct match
13. The secondary threshold where confidence is high enough after an exhaustive search has completed
14. The resulting language—if a language is supplied all subtitles are passed through a translation service before being blocked
15. The maximum character width for subtitle blocks
16. The number of CPU's to use during cross correlation

1. A method of retrieving supplementary data related to audio-video content with reference to a reference version of that content, comprising:
processing an audio component of the audio-video content to derive an audio signature of the audio-video content;
searching reference audio signatures derived from audio components of reference audio-video content by comparing the audio signature of the audiovideo content to the reference audio signatures; and
if a match is found, retrieving supplementary data related to the reference audio-video content for which the match was found;
wherein the search is a directed search using data extracted from the transmission route by which the audio-video content is to be delivered to a consumer.

2. (canceled)

3. A method according to claim 1, wherein the data extracted from the transmission route comprises a time and date stamp and the directed search comprises at least one of:
searching the reference content by comparing a date for each piece of reference audio-video content starting with a date near the date indicated by the time and date stamp; and
searching from the date indicated by the date and time stamp in both increasing and decreasing date order.

4. (canceled)

5. A method according to claim 1, wherein the data extracted from the transmission route comprises a time and date stamp and the date of each piece of reference audio-video content is a date of broadcast of the reference audio-video content.

6. A method according to claim 1, wherein the data extracted from the transmission route comprises one or more of a program name, program ID or channel and the directed search initially limits the search based on the extracted data.

7. (canceled)

8. (canceled)

9. A method according claim 1, wherein the audio signature is a time varying function and wherein comparing the audio signature of the audiovideo content to the reference audio signatures comprises comparing a portion of the time varying function to the reference audio signatures.

10. A method according to claim 9, wherein the comparing comprises a sliding comparison of the portion of the signature relative to each reference signature and wherein the sliding comparison is arranged to establish both a match and relative time offset of the portion of the signature and the reference audio signature.

11. (canceled)

12. A method according to claim 9, further comprising varying the duration of the portion of the signature wherein varying the duration comprises increasing the duration after a corresponding reference signature has been found until the portion of the signature and reference signature no longer match.

13. (canceled)

14. A method according to claim 12, further comprising selecting a second portion of the signature after the first portion and comparing the second portion to the reference signature for which a match has been found.

15. A method according to claim 9, comprising selecting a portion of the signature, comparing the portion to the reference signatures to establish a match and the repeated steps of:
increasing the selected portion of the signature until the point that the portion would no longer match the previously matched reference signature;
selecting a new selected portion adjacent the previously selected portion; whereby multiple portions of the signature are matched to portions of one of the reference signatures.

16. (canceled)

17. A method according to claim 1, wherein the searching comprises determining in turn whether a function of the audio signature and each of the reference audio signatures meets a threshold test.

18. (canceled)

19. (canceled)

20. A method according to claim 1, wherein the supplementary data comprises subtitles.

21. A method according to claim 20, further comprising re-timing the subtitles using information indicating the timing offset between the signature and matching reference signature.

22. (canceled)

23. (canceled)

24. (canceled)

25. A system for retrieving supplementary data related to audio-video content with reference to a reference version of that content, comprising:
means for processing an audio component of the audio-video content to derive an audio signature of the audio-video content;
means for searching reference audio signatures derived from audio components of reference audio-video content by comparing the audio signature of the audio-video content to the reference audio signatures; and
means, if a match is found, for retrieving supplementary data related to the reference audio-video content for which the match was found;
wherein the search is a directed search using data extracted from the transmission route by which the audio-video content is to be delivered to a consumer.

26. (canceled)

27. A system according to claim 25, wherein the data extracted from the transmission route comprises a time and date stamp and the directed search comprises at least one of:
searching the reference content by comparing a date for each piece of reference audio-video content starting with a date near the date indicated by the time and date stamp: and
searching from the date indicated by the date and time stamp in both increasing and decreasing date order.

28. (canceled)

29. A system according to claim 25, wherein the data extracted from the transmission route comprises a time and dale stamp and the date of each piece of reference audio-video content is a date of broadcast of the reference audio-video content.

30. (canceled)

31. A system according to claim 25, wherein the audio video content is from a downloadable source and the retrieving supplementary data comprises making the supplementary data available on the downloadable source.

32. A system according to claim 25, wherein the transmission route comprises download from the Internet and the data extracted from the transmission route is from a URL of the audio-video content.

33. A system according to claim 25, wherein the audio signature is a time varying function and wherein comparing the audio signature of the audio-video content to the reference audio signatures comprises comparing a portion of the time varying function to the reference audio signatures.

34. A system according to claim 33, wherein the comparing comprises a sliding comparison of the portion of the signature relative to each reference signature wherein the sliding comparison is arranged to establish both a match and relative time offset of the portion of the signature and the reference audio signature.

35. (canceled)

36. A system according to claim 33, further comprising varying the duration of the portion of the signature wherein varying the duration comprises increasing the duration after a corresponding reference signature has been found until the portion of the signature and reference signature no longer match.

37. (canceled)

38. A system according to claim 36, further comprising selecting a second portion of the signature after the first portion and comparing the second portion to the reference signature for which a match has been found.

39. A system according to claim 33, comprising selecting a portion of the signature, comparing the portion to the reference signatures to establish a match and the repeated steps of:
increasing the selected portion of the signature until the point that the portion would no longer match the previously matched reference signature;
selecting a new selected portion adjacent the previously selected portion; whereby multiple portions of the signature are matched to portions of one of the reference signatures.

40. (canceled)

41. (canceled)

42. (canceled)

43. (canceled)

44. A system according claim 25, wherein the supplementary data comprises subtitles.

45. A system according to claim 25, further comprising re-timing the subtitles using information indicating the timing offset between the signature and matching reference signature.

46. A system according to claim 25, further comprising monitoring the storing of content broadcast on a broadcast network and adding signatures of such content to a database as the content is broadcast or stored.

47. A system according to claim 25, wherein searching the reference audio signatures comprises searching a database containing the reference audio signatures.

48. A system according to claim 25, wherein processing the audio component of the audio-video content to derive an audio signature comprises using feature extraction or a mathematical transform.

49. (canceled)

50. (canceled)
